(19) United States
(12) Patent Application Publication
(10) Pub. No.: US 2019/0351764 A1
(43) Pub. Date: Nov. 21, 2019

(54) VEHICLE SAFETY LOCK ASSEMBLY

(71) Applicant: Guadalupe Ramon Gil Vera, Portland, OR (US)

(72) Inventor: Guadalupe Ramon Gil Vera, Portland, OR (US)

(21) Appl. No.: 15/983,716

(22) Filed: May 18, 2018

(51) Int. Cl. B60K 28/08; H04M 1/725; B60R 11/02

(52) U.S. Cl. CPC B60K 28/08; B60K 2028/003; B60R 11/0241; H04M 1/7253

(57) ABSTRACT

A vehicle safety lock assembly includes a vehicle that has an ignition system. An electronic device is provided that has a transceiver. A docking unit is coupled to the vehicle, the docking unit is positioned in an interior of the vehicle and the docking unit is electrically coupled to the ignition system. The docking unit is in wireless communication with the electronic device when the electronic device is brought into the vehicle. Moreover, the docking unit senses when the electronic device is positioned therein for storage. The docking unit turns the ignition system off when the docking unit senses the electronic device is brought into the vehicle and the electronic device is not positioned in the docking unit. In this way the docking unit inhibits the vehicle from is driven when the electronic device is available to be manipulated by the driver. The docking unit turns the ignition system on when the electronic device is brought into the vehicle and the electronic device is positioned in the docking unit.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to safety devices and more particularly pertains to a new safety device for restricting a vehicle from being driven when an active electronic device is brought into the vehicle.

### BRIEF SUMMARY OF THE INVENTION

An embodiment of the disclosure meets the needs presented above by generally comprising a vehicle that has an ignition system. An electronic device is provided that has a transceiver. A docking unit is coupled to the vehicle, the docking unit is positioned in an interior of the vehicle and the docking unit is electrically coupled to the ignition system. The docking unit is in wireless communication with the electronic device when the electronic device is brought into the vehicle. Moreover, the docking unit senses when the electronic device is positioned therein for storage. The docking unit turns the ignition system off when the docking unit senses the electronic device is brought into the vehicle and the electronic device is not positioned in the docking unit. In this way the docking unit inhibits the vehicle from is driven when the electronic device is available to be manipulated by the driver. The docking unit turns the ignition system on when the electronic device is brought into the vehicle and the electronic device is positioned in the docking unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a vehicle safety lock assembly according to an embodiment of the disclosure.

FIG. 2 is a schematic view of an embodiment of the disclosure.

### DETAILED DESCRIPTION OF THE INVENTION

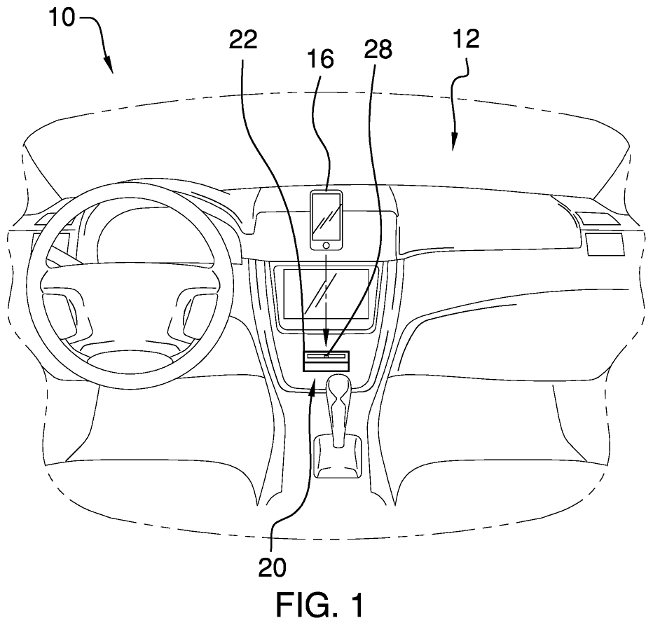

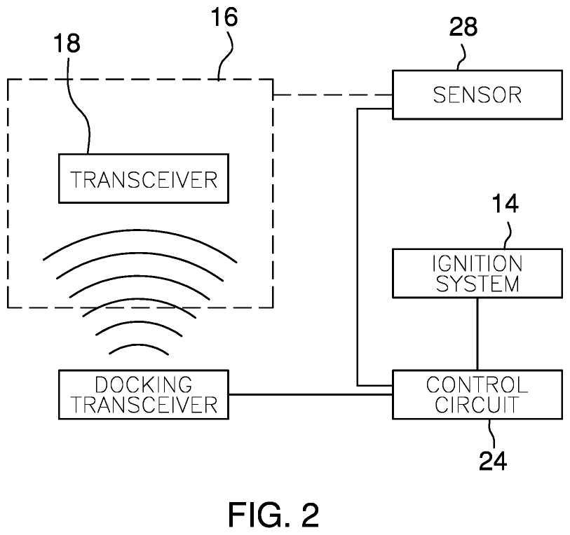

With reference now to the drawings, and in particular to FIGS. 1 through 2 thereof, a new safety device embodying the principles and concepts of an embodiment of the disclosure and generally designated by the reference numeral 10 will be described.

As best illustrated in FIGS. 1 through 2, the vehicle safety lock assembly 10 generally comprises a vehicle 12 that has an ignition system 14. The vehicle 12 may be a passenger vehicle 12 or any other motorized vehicle 12. An electronic device 16 is included and the electronic device 16 has a transceiver 18. The electronic device 16 may be a smart phone or other similar wireless communication device.

A docking unit 20 is coupled to the vehicle 12 and the docking unit 20 is positioned in an interior of the vehicle 12 to be accessible to a driver. The docking unit 20 is electrically coupled to the ignition system 14 and the docking unit 20 is in wireless communication with the electronic device 16 when the electronic device 16 is brought into the vehicle 12. The docking unit 20 senses when the electronic device 16 is positioned therein for storage. Moreover, the docking unit 20 turns the ignition system 14 off when the docking unit 20 senses the electronic device 16 has been brought into the vehicle 12 and the electronic device 16 is not positioned in the docking unit 20. In this way the docking unit 20 inhibits the vehicle 12 from being driven while the electronic device 16 is available to be used by the driver. The docking unit 20 turns the ignition system 14 on when the electronic device 16 is brought into the vehicle 12 and the electronic device 16 is positioned in the docking unit 20.

The docking unit 20 comprises a receptacle 22 that is positioned within the vehicle 12. A control circuit 24 is positioned in the receptacle 22 and the control circuit 24 is electrically coupled to the ignition system 14. The receptacle 22 may be a locking box, a smart phone dock and any other type of receptacle 22 that can physically engage or receive a smart phone. A docking transceiver 26 is positioned within the receptacle 22 and the docking transceiver 26 is electrically coupled to the control circuit 24. The docking transceiver 26 may be a radio frequency transceiver or the like and the docking transceiver 26 may employ a WPAN signal and Bluetooth communication protocols. Additionally, the docking transceiver 26 may be in electrical communication with a wireless communication system in the vehicle 12 such as are included in hands free telephony systems in modern vehicles.

The docking transceiver 26 is in electrical communication with the transceiver 18 in the electronic device 16 when the electronic device 16 is brought within the vehicle 12. The docking transceiver 26 may have an operational range of approximately 2.0 meters. Thus, the docking transceiver 26 cannot communicate with the electronic device 16 until the electronic device 16 is brought within the vehicle 12. The control circuit 24 receives a first input when the docking transceiver 26 is in communication with the transceiver 18 in the electronic device 16. Moreover, the control circuit 24 turns the ignition system 14 off when the control circuit 24 receives the first input. In this way the control circuit 24 inhibits the vehicle 12 from being driven when the electronic device 16 is within the vehicle 12 and available for the driver to use.

A sensor 28 is coupled to the receptacle 22 and the sensor 28 is electrically coupled to the control circuit 24. The sensor 28 is placed in electrical communication with the electronic device 16 when the electronic device 16 is positioned in the receptacle 22. The control circuit 24 receives a second input when the sensor 28 is in electrical communication with the electronic device 16. Additionally, the control circuit 24 turns the ignition system 14 on when the control circuit 24 receives the second input after receiving the first input. In this way the control circuit 24 facilitates the vehicle 12 to be driven. The sensor 28 may be an electrical connector that engages a port on the electronic device 16 or other electronic sensor 28 that is capable of communicating with the electronic device 16.

In use, the docking transceiver 26 detects the signal broadcast by the transceiver 18 in the electronic device 16 when the electronic device 16 is brought into the vehicle 12. Thus, the control circuit 24 receives the first input and turns the vehicle 12's ignition system 14 off. In this way the vehicle 12 is inhibited from being driven while the electronic device 16 is active and inside the vehicle 12. The sensor 28 is placed in electrical communication with the electronic device 16 when the electronic device 16 is placed in the receptacle 22. Thus, the control circuit 24 receives the second signal and turns the vehicle 12's ignition system 14 on. In this way the vehicle 12 can be driven without the possibility of the driver manipulating the electronic device 16 while driving thereby enhancing safety of operating the vehicle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle safety lock assembly being configured to inhibit a smart phone from being used during driving, said assembly comprising:
a vehicle having an ignition system;
an electronic device having a transceiver; and
a docking unit being coupled to said vehicle and being positioned in an interior of said vehicle wherein said docking unit is configured to be accessible to a driver, said docking unit being electrically coupled to said ignition system, said docking unit being in wireless communication with said electronic device when said electronic device is brought into said vehicle, said docking unit sensing when said electronic device is positioned therein for storage, said docking unit turning said ignition system off when said docking unit detects that said electronic device is brought into said vehicle and said electronic device is not positioned in said docking unit thereby inhibiting said vehicle from being driven, said docking unit turning said ignition system on when said electronic device is brought into said vehicle and said electronic device is positioned in said docking unit.

2. The assembly according to claim 1, wherein said docking unit comprises a receptacle being positioned within said vehicle.

3. The assembly according to claim 2, further comprising a control circuit being positioned in said receptacle, said control circuit being electrically coupled to said ignition system.

4. The assembly according to claim 3, further comprising a docking transceiver being positioned within said receptacle, said docking transceiver being electrically coupled to said control circuit, said docking transceiver being in electrical communication with said transceiver in said electronic device when said electronic device is brought within said vehicle.

5. The assembly according to claim 4, wherein said control circuit receives a first input when said docking transceiver is in communication with said transceiver in said electronic device.

6. The assembly according to claim 5, wherein said control circuit turning said ignition system off when said control circuit receives said first input such that said control circuit inhibits said vehicle from being driven.

7. The assembly according to claim 3, further comprising a sensor being coupled to said receptacle, said sensor being electrically coupled to said control circuit, said sensor being placed in electrical communication with said electronic device when said electronic device is positioned in said receptacle.

8. The assembly according to claim 7, wherein said control circuit receives a first input, said control circuit receiving a second input when said sensor is in electrical communication with said electronic device.

9. The assembly according to claim 8, wherein said control circuit turns said ignition system on when said control circuit receives said second input after receiving said first input such that said control circuit facilitates said vehicle to be driven.

10. A vehicle safety lock assembly being configured to inhibit a smart phone from being used during driving, said assembly comprising:
a vehicle having an ignition system;
an electronic device having a transceiver;
a docking unit being coupled to said vehicle and being positioned in an interior of said vehicle wherein said docking unit is configured to be accessible to a driver, said docking unit being electrically coupled to said ignition system, said docking unit being in wireless communication with said electronic device when said electronic device is brought into said vehicle, said docking unit sensing when said electronic device is positioned therein for storage, said docking unit turning said ignition system off when said docking unit said electronic device is brought into said vehicle and said electronic device is not positioned in said docking unit thereby inhibiting said vehicle from being driven, said docking unit turning said ignition system on when said electronic device is brought into said vehicle and said electronic device is positioned in said docking unit, said docking unit comprising:
a receptacle being positioned within said vehicle;
a control circuit being positioned in said receptacle, said control circuit being electrically coupled to said ignition system;
a docking transceiver being positioned within said receptacle, said docking transceiver being electrically coupled to said control circuit, said docking transceiver being in electrical communication with said transceiver in said electronic device when said electronic device is brought within said vehicle, said control circuit receiving a first input when said docking transceiver is in communication with said transceiver in said electronic device, said control circuit turning said ignition system off when said control circuit receives said first input such that said control circuit inhibits said vehicle from being driven; and
a sensor being coupled to said receptacle, said sensor being electrically coupled to said control circuit, said sensor being placed in electrical communication when said electronic device when said electronic device is positioned in said receptacle, said control circuit receiving a second input when said sensor is in electrical communication with said electronic device, said control circuit turning said ignition system on when said control circuit receives said second input after receiving said first input such that said control circuit facilitates said vehicle to be driven.
